(19) United States
(12) Patent Application Publication
(10) Pub. No.: US 2007/0268067 A1
(43) Pub. Date: Nov. 22, 2007

(54) Method and Device for Acquiring a Position of a Motor Vehicle on a Road

(75) Inventors: Werner Bernhard, Filderstadt (DE); Carsten Knoeppel, Stuttgart (DE); Uli Kolbe, Stuttgart (DE); Alexander Schanz, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/571,670

(22) PCT Filed: Aug. 18, 2004
(86) PCT No.: PCT/EP04/09234

§ 371 Date: Feb. 1, 2007

(30) Foreign Application Priority Data
Sep. 11, 2003 (DE) 103 41 905.5

(51) Int. Cl. G05F 1/00

(52) U.S. Cl. 327/558

(57) ABSTRACT

A method for acquiring a position (1) of a motor vehicle (2) on a road (3), road geometric data (4) and travel data (5) being recorded. First position data (1) of the motor vehicle (2) relative to the road (3) is calculated from the recorded road geometric data (4) and travel data (5). Road course data (6) is calculated from the road geometric data (4) and the travel data (5), the second position data (7) of a following vehicle (21) which is following the vehicle (2), relative to the vehicle (2), is recorded, and third position data (8) of the following vehicle (21) relative to the road (3) is calculated from the road course data (6), the first position data (1) of the vehicle (2) and the second position data (7) of the following vehicle (2′).

### BACKGROUND AND SUMMARY OF THE INVENTION

The invention relates to a method for monitoring the area behind a motor vehicle, in which the position of a motor vehicle on a road is acquired.

German Patent document DE 199 21 437 A1 discloses a method for acquiring a position of a vehicle on a road. There is provision here for road geometric data and travel data of the vehicle to be acquired and for the position of the vehicle on the road to be determined by comparing the road geometric data with the travel data. Since in this way both the road geometric data and the travel data of the vehicle can be recorded when the vehicle is traveling, the vehicle can be directly assigned to a lane and the instantaneous position of the vehicle can thus be determined precisely. The travel data is acquired here, for example, from a travel/speed signal and/or a steering angle and/or wheel speed sensor and/or with satellite support by means of GPS.

European Patent documents EP 1 262 739, EP 1 245 443 and EP 1 033 693 disclose further methods for representing the position of a vehicle on a road.

German Patent document DE 100 59 900 A1 discloses a method for presenting graphic information about the surroundings of an observer from a bird's eye view. In particular in order to provide support when operating motor vehicles, the graphic information on the surroundings is thus displayed to an observer from a bird's eye view, with moving objects within the image data being detected. The method provides the possibility of making available the parameters of the detected objects to a system or to a person for further processing.

It is conceivable here that the driving area which is described by location parameters and cannot be traveled in is composed of one region or else is formed from a plurality of incoherent partial regions. In this context, it is possible to have recourse to methods which are known from stereoscopic image processing. Image data which is processed in this way can then be displayed by means of a display unit, and the observer can be presented symbolically within the image data at the location in the scene where said observer is situated. In addition, information about a free driving area can be transmitted via a telecommunications system to other road users or to a traffic control center for further processing. It is also conceivable for this free traffic area or parts thereof to be checked for their suitability as a parking area so that a driving area which is suitable as a parking area is signaled to a traffic control center or to a driver of a vehicle.

Germant Patent document DE 44 21 805 C1 discloses a method for the orientation, route planning and control of an autonomous, mobile unit. Different bonus and penalty points are allocated for each component task such as for example: drive from A to B, keep your position uncertainty below a specific threshold or create a map of the surroundings and add landmarks to it. In conjunction with a need to carry out these tasks, execution weightings for the individual tasks, which are evaluated in a control unit, arise after the bonus points and penalty points have been analyzed. As a function of these weightings, a corresponding component task is selected and a corresponding intermediate task is defined. In this context, the position uncertainty of the autonomous and mobile unit is continuously monitored and when a specific value is exceeded a suitable measure is carried out in order to measure the current position and thus reduce the accrued error. The described method is applied namely in industrial and domestic robots as well as transportation vehicles.

German Patent document DE 100 41 277 A1 discloses a method and a system for autonomously developing or expanding geographic databases by using coordinated measurement data. Here, an overview is provided by means of geospatial information on a specific area in which a number of uncoordinated measuring vehicles is moving. The measuring vehicles are equipped with a position determining system and collect specific geospatial information as they move in the area. This specific information from the measuring vehicles is combined over time to form a data record. A central processor analyzes the data record to determine geospatial information of relatively high quality. The described development system and method is mainly used to develop and/or refine digital maps on the basis of position measurements (the geospatial information) which is generated by the measurement systems equipped with the global positioning system receivers.

U.S. Pat. No. 6,429,789 B1 discloses a method in which road geometric data and vehicle data are recorded and an image of the surroundings of the vehicle from said data is displayed on a display. The image displayed in the vehicle can have various formats, for example a bird's eye view or a three-dimensional representation. The geometry of the road is recorded by means of sensors and the course of the road is calculated therefrom. In addition, the position of obstacles relative to the vehicle is displayed.

The present invention is therefore concerned with the problem of specifying an improved embodiment for a method of the type mentioned at the beginning, which permits in particular an area behind a motor vehicle to be reliably monitored, and the driving safety to be thus increased, by suitably recording and processing data.

The invention is based on the general idea of assigning detected vehicles traveling on a road to a lane using a local map. The position data of the detected vehicle relative to the road can be acquired with the acquired lane information on the map. The lane information is determined from the distance traveled by the respective vehicle, for which purpose road markings/landmarks (road geometric data) is recorded, said data being detected in the proximity of the vehicle and being incorporated into the map in relation to the respective route.

In the method according to the invention, the described road geometric data is recorded together with the travel data. First position data of the motor vehicle relative to the road is calculated from the recorded road geometric data and the travel data. According to the invention, road course data is then calculated from the recorded road geometric data and the travel data. The road course data is further processed and stored and represents the course of a road in a specific region. Furthermore, second position data of a following vehicle which is following the vehicle, relative to the vehicle, is recorded and third position data of the following vehicle relative to the road is calculated from the road course data, the first position data of the vehicle and the second position data of the following vehicle.

The acquisitions of the travel data which serves as the basis for the calculation of the position data of the vehicle is described, on the one hand, by the movement of the vehicle by the distance D and, on the other hand, by the change in direction in the form of a rotation about a specific angle ψ.

In order to obtain a high quality of the road geometric data, travel data and the course of the road formed therefrom, it is necessary to determine the change in direction and the distance precisely. For this purpose, wheel speeds of the vehicle are evaluated in combination with measured values from the system for recording the road geometric data.

Generally, the method permits an area behind the vehicle to be monitored and the objects or vehicles detected in this area behind the vehicle to be assigned to a lane. As a result, a driver can be warned, for example when changing lane to a target lane to overtake another vehicle, about a fast vehicle which is following the driver's vehicle and is traveling on the target lane, permitting collisions to be avoided and generally driving safety to be increased.

According to one advantageous development, the road geometric data is acquired using a stereoscopic camera which is arranged on the rear of the vehicle. In this context, the stereoscopic camera records landmarks which are formed by 3-D points and which have a fixed position, for example road marking, relative to the road. It is generally also conceivable that, in addition to the recording of the road geometric data, the stereoscopic camera additionally also records following vehicles in terms of their vehicle speed and/or their position.

According to one preferred embodiment of the solution according to the invention it is possible to provide for the road course data to be calculated according to the Kalman filter principle. For this purpose, position data of the vehicle composed of the individual wheel speeds of the respective vehicle and landmark positions which are recorded with the stereoscopic camera are fed to the Kalman filter. In the process, in particular interference, which adversely affects the quality of the acquired travel data, for example as a result of different wheel circumferences or side wind, is suppressed using the landmarks acquired by the stereoscopic camera.

Further important features and advantages of the invention emerge from the subclaims, from the drawings and from the associated descriptions of the figures with reference to the drawings.

Of course, the features mentioned above and the features to be explained below can be used not only in the respectively specified combination but also in other combinations or alone without departing from the scope of the present invention.

Preferred exemplary embodiments of the invention are presented in the drawings and explained in more detail in the following descriptions, reference symbols referring to identical or similar or functionally identical components.

### BRIEF DESCRIPTION OF THE DRAWINGS

FIG. 1 is a basic illustration of the acquisition of a road course,

FIG. 2 shows a distance traveled by a vehicle and its position in a lane at different acquisition times,

FIG. 3 shows a distance traveled with a change in direction between two recording times in an initial coordinate system,

FIG. 4 shows landmark positions in the initial and in the vehicle coordinate system,

FIG. 5a is a diagram showing the deviation of the maximum position errors as a function of the number of landmarks, and

FIG. 5b is a diagram as in FIG. 5a, but showing the deviation of the average position errors as a function of the number of landmarks.

### DETAILED DESCRIPTION OF THE DRAWINGS

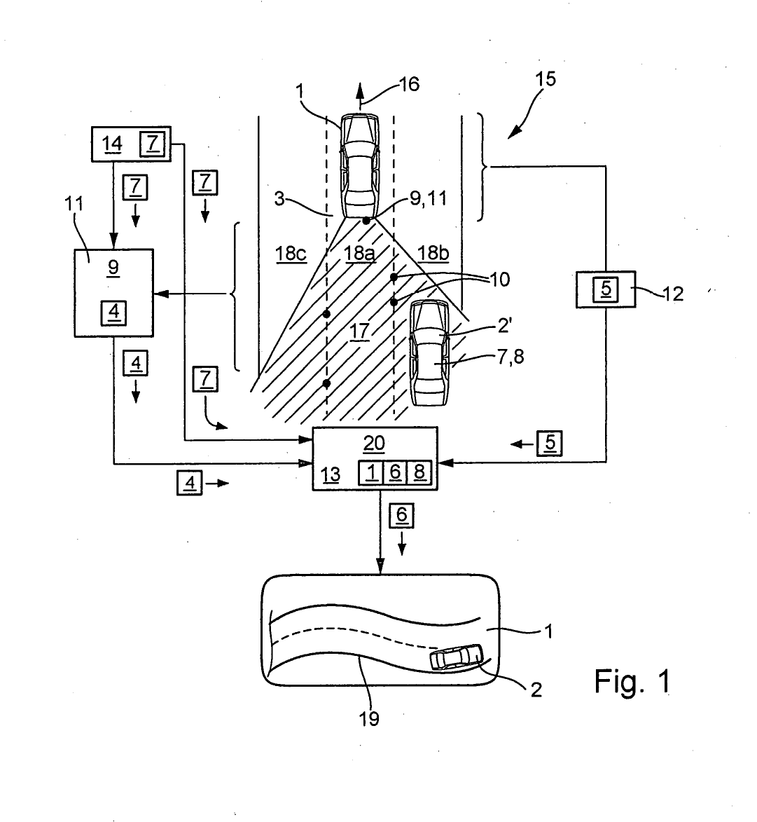

According to FIG. 1, an apparatus 15 for acquiring a position of a motor vehicle 2 on a road 3 has a first device 11 for recording road geometric data 4. The first device 11 may be arranged on the rear of the motor vehicle 2 and be embodied as a stereoscopic camera 9 which, according to FIG. 1, detects an area behind the motor vehicle 2, through which the motor vehicle has traveled. The road geometric data 4 recorded by the stereoscopic camera 9 is obtained, for example, from fixed location 3-D points 10, for example from road markings near to the vehicle or other landmarks.

A recording area 17 of the stereoscopic camera 9 is embodied in such a way that as the distance from the motor vehicle 2 increases at least one recording width increases. Starting from a predefined distance not only refers to a first lane 18a on which the motor vehicle 2 moves in the direction of travel 16 but also adjacent lanes 18b and 18c or edge regions extending beyond them are recorded.

Furthermore, a second device 12, for example a vehicle sensor, is provided for recording travel data 5. The travel data 5 describes, in particular, the speed and direction of movement of the vehicle. For example wheel speeds, which travel a predefined distance per revolution irrespective of the circumference of the wheels of the motor vehicle 2 are used to record travel data 5.

In addition to the first device 11 and the second device 12, a control device 13 is provided and the road geometric data 4 acquired by the first device 11 and the stereoscopic camera 9 as well as the travel data 5 acquired by the second device 12 are fed to said control device 13 for further processing. The control device 13 is designed to calculate first position data 1 of the motor vehicle 2 relative to the road 3 and is also capable of calculating road course data 6 from the road geometric data 4 and the travel data 5. The road course data 6 represents in the evaluated state, a route 15 through which the motor vehicle 2 has traveled. The control device 13 preferably contains a Kalman filter arrangement 20 and operates according to the Kalman filter principle on which further details will be given below.

In addition to the first device 11 and the second device 12, a third device 14 is provided which, according to FIG. 1, is connected to the first device 11 and which is designed to record second position data 7 of a following vehicle 2′, which is following the vehicle 2, relative to the vehicle 2. It is conceivable that, according to FIG. 1, the third device 14 is made separate from the first device 11 or is integrated partially or completely into it. The third device 11 has suitable means for recording the area behind the vehicle. It may be expediently provided for the stereoscopic camera 9 to record the road geometric data 4 and/or the second position data 7 of the following vehicle 2′.

The apparatus 15 according to the invention calculates with the control unit 13, third position data 8 of the following vehicle 2′ relative to the road 3 from the road course data 6, the first position data 1 of the vehicle 2 and the second position data 7 of the following vehicle 2′.

The apparatus 15 according to the invention thus permits the area behind the motor vehicle 2 to be monitored and the objects or following vehicles 2′ detected in this area behind the vehicle to be assigned to the respective vehicle's own lane 18a or an adjacent lane, for example 18b or 18c.

The method of functioning of the apparatus 15 according to the invention will now be explained briefly below:

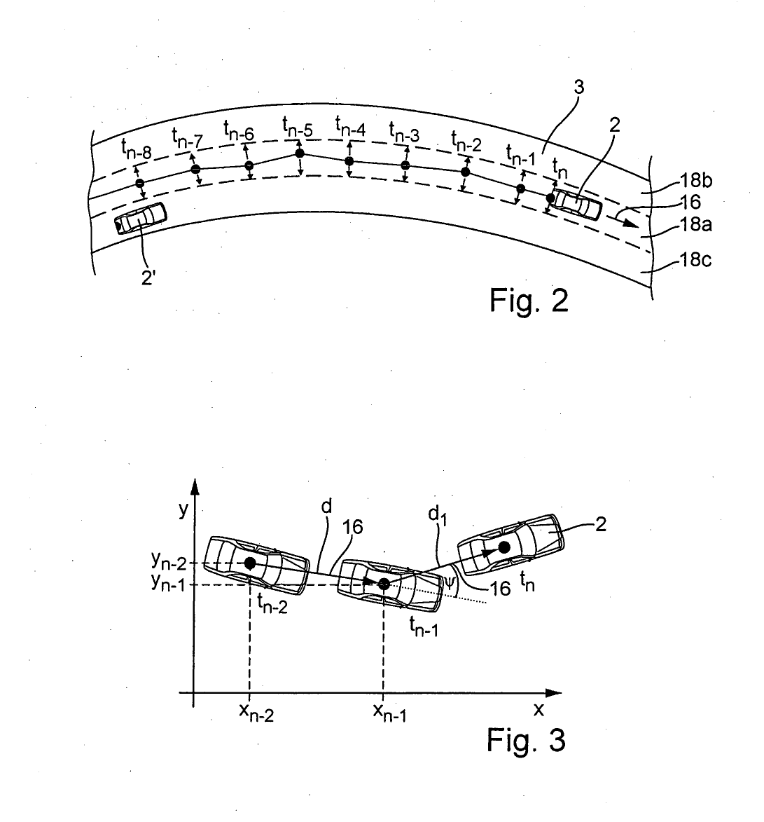

The idea of the invention consists in assigning detected vehicles 2′ to lanes using a local map (cf. FIG. 2). The position of the detected vehicles 2′ relative to the route 19 of the respective vehicle 2 can be determined with lane information from this local map. The lane information is determined from the distance 19 traveled by the respective vehicle 2, for which purpose road geometric data 4, in particular road markings, are detected in the vicinity of the vehicle 2 and incorporated into the map in relation to the respective route 19. The lane information can be acquired continuously or, as shown in FIG. 2, at specific recording times tₙ₋ₓ to tₙ (x ∈ {1,2,3 . . . n}).

In order to acquire the distance 19 traveled by the respective vehicle 2, the first position data 1 is input into a coordinate system (cf. FIG. 3) which is located relative to the road 3. The position changes of the vehicle 2 can be described by means of two variables:
by displacing the vehicle by the distance d and
by changing the direction of the vehicle in the form of a rotation about the angle ψ.

According to FIG. 3, the vehicle 2 moves a specific distance d in the initial coordinate system during the time period tₙ₋₂ to tₙ₋ₗ, which distance d can be calculated according to the Pythagorean theorem from the coaxial distances in the x and y direction traveled during the time period tₙ₋₂ to tₙ₋₁.

Between the times tₙ₋₁ to tₙ, the vehicle 2 moves the distance d₁, which can likewise be calculated according to the Pythagorean theorem from the coaxial travel components during the specified time period. At the same time, the motor vehicle 2 changes its direction by the angle ψ at the time tₙ₋₁. The current position 1 of the motor vehicle 2 can be calculated in the initial coordinate system at the time tₙ from the distance thus traveled during a certain time period and from the change in angle which has been carried out in the process.

In order to calculate the second position data 7 of the vehicle 2 relative to the road 3, the road geometric data 4 acquired by the stereoscopic camera 9 and the travel data 5 are fed to the control device 13. Said control device 13 forms a relationship between the coordinate system relative to the vehicle 2 and the initial coordinate system relative to the road 3 by setting up the following equation system:
x′ᵢ=−(xᵢ−x)·cos ψ−(yᵢ−y)·sin ψ (1)
z′ᵢ=−(xᵢ−x)·sin ψ+(yᵢ−y)·cos ψ (2)

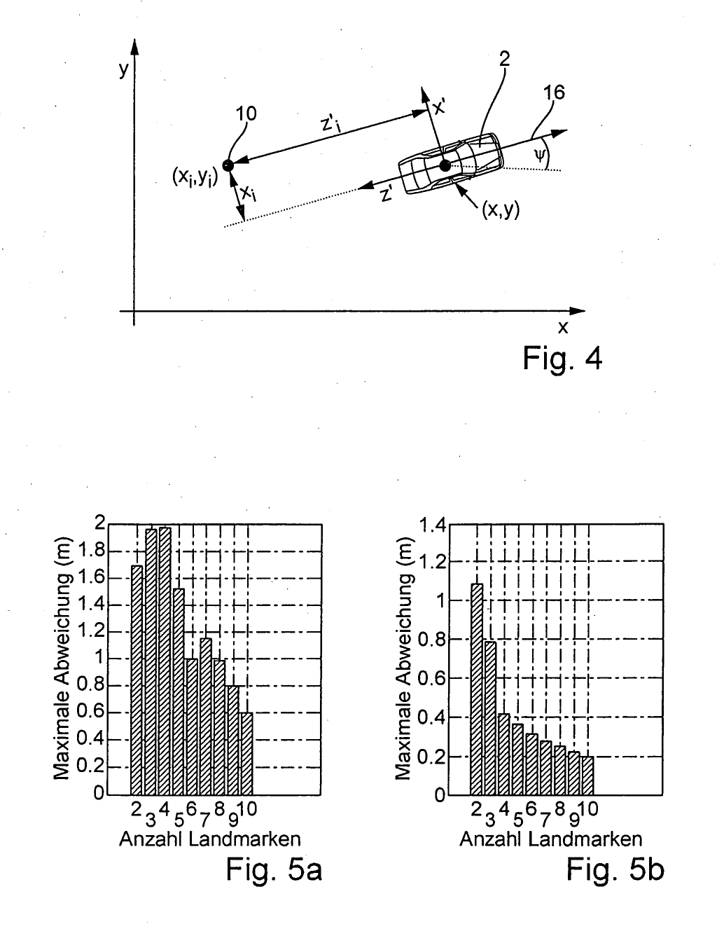

Here, the coordinates (x′ᵢ,z′ᵢ) of a rotationally fixed 3-D point 10, for example a landmark, refer to the coordinate system relative to the vehicle 2, and the coordinates (xᵢ, zᵢ) refer to the initial coordinate system relative to the road 3. The vehicle position 1 is described by (x, y) and its position by the angle ψ in the initial coordinate system (cf. FIG. 4).

The equations (1) and (2) represent nonlinear measurement equations for the Kalman filter 20. In order to be able to process a large amount of road geometric data 4 in the Kalman filter 20, the measurement equations of all the road geometric data 4 are combined in the measurement matrix h(x). The matrix is thus as follows for n road geometric data items 4:

$$h ( x ) = [ \begin{matrix}{x}_{i}^{′} \\ {z}_{i}^{′} \\ ⋮ \\ {x}_{n}^{′} \\ {z}_{n}^{′}\end{matrix} ] = [ \begin{matrix}- ( {x}_{1} - x ) \cdot cos ψ - ( {y}_{1} - y ) \cdot sin ψ \\ - ( {x}_{1} - x ) \cdot sin ψ - ( {y}_{1} - y ) \cdot cos ψ \\ ⋮ \\ - ( {x}_{n} - x ) \cdot cos ψ - ( {y}_{n} - y ) \cdot sin ψ \\ - ( {x}_{n} - x ) \cdot cos ψ - ( {y}_{n} - y ) \cdot cos ψ\end{matrix} ] \qquad ( 3 )$$

Since the measurement equations are not linear, linearization is carried out for treatment in the Kalman filter 20. The linearized measurement matrix H(x) can be calculated by means of the Jacobi matrix from h(x) at the current working point. The linearized measurement matrix H(x) is as follows:

$${H}_{( x )} = \frac{\partial h ( x )}{\partial x} = [ \begin{matrix}cos ψ & sin ψ + sin ψ \cdot ( {x}_{1} - x ) - cos ψ \cdot ( {y}_{1} - y ) \\ sin ψ & - cos ψ - cos ψ \cdot ( {x}_{1} - x ) - sin ψ \cdot ( {y}_{1} - y ) \\ & ⋮ \\ cos ψ & sin ψ + sin ψ \cdot ( {x}_{n} - x ) - cos ψ \cdot ( {y}_{n} - y ) \\ sin ψ & - cos ψ - cos ψ \cdot ( {x}_{n} - x ) - sin ψ \cdot ( {y}_{n} - y )\end{matrix} ] \qquad ( 4 )$$

The linearized measurement matrix H(x) is then to calculate a boosting matrix Kₖ of the Kalman filter 20. It is calculated as:

$$\begin{matrix}{K}_{k} = \frac{{P}_{k}^{*} \cdot {H}_{k}^{T}}{{H}_{k} \cdot {P}_{k}^{*} \cdot {H}_{k}^{T} + {R}_{k}} \\ and also as : & ( 5 ) \\ {{x}^{⋒}}_{k} = {x}_{k}^{*} + {K}_{k} ( {y}_{k} - h ( {x}_{k}^{*} ) ) & ( 6 )\end{matrix}$$

The filter of the expanded Kalman filter 20 is implemented with the nonlinear measurement matrix h(x) since using the linearized measurement matrix H(x) would cause linearization errors to be unnecessarily included. The filter equation is as follows:

$$y = [ \begin{matrix}{x}_{i}^{′} \\ {z}_{i}^{′} \\ ⋮ \\ {x}_{n}^{′} \\ {z}_{n}^{′}\end{matrix} ] \qquad ( 7 )$$

The measurement vector y contains here the individual road geometric coordinates 4 relative to the vehicle 2.

According to FIGS. 5a and 5b, a maximum deviation, and an average deviation, of position errors decrease as the number of evaluated road geometric data items 4 increases. Thus, an average deviation of the position errors for two road geometric data items 4 (landmarks) is approximately 0.8 m, whereas it is only approximately 0.2 m for nine evaluated landmarks. It is similar for the maximum deviation of the position errors. Here, for an evaluation of the same number of landmarks this drops from 1.95 m to 0.8 m.

To summarize, the essential features of the invention can be characterized as follows:

The invention provides for vehicles 2′ which are detected traveling behind the respective vehicle 2 on a road 3 to be assigned to lanes using a local map. The position data 7 of the detected vehicle 2′ relative to the road 3 can be acquired using the acquired lane information on the map. The lane information is determined here from the distance 19 traveled by the respective vehicle 2, for which distance 19 road geometric data 4 is recorded, said data 4 being detected in the vicinity of the vehicle 2 and being incorporated into the map relative to the respective distance.

In the method according to the invention, the described road geometric data 4 and travel data 5 is recorded, first position data 1 of the motor vehicle 2 relative to the road 3 being calculated from these data items. It is essential to the invention that road course data 6 is calculated from the recorded road geometric data 4 and the travel data 5, is further processed and stored and represents the course of the road (distance 19) in a specific region. Furthermore, second position data 7 of a following vehicle 2′ which is following the vehicle 2, relative to the vehicle 2 is recorded and third position data 8 of the following vehicle 2′ relative to the road 3 is calculated from the road course data 6, the first position data 1 of the vehicle 2 and the second position data 7 of the following vehicle 2′.

Generally, the method permits an area behind the vehicle 2 to be monitored and the objects or vehicles 2′ which are detected in this area behind the vehicles to be assigned to a lane.

In the process, the road geometric data 4 can be acquired with a stereoscopic camera 9 which is arranged on the rear of the vehicle 2, whereas the second position data 7 of the following vehicle 21 is recorded with the third device 14.

1-7. (canceled)

8. A method for monitoring the area behind a motor vehicle in which the position of a first motor vehicle on a road is acquired, the road geometric data relating to the area behind the vehicle and travel data being recorded and the travel data describing the movement of the vehicle by a distance (d), in which first position data of the first motor vehicle relative to the road is calculated from the recorded road geometric data and travel data, road course data being calculated from the road geometric data and the travel data, and a local map being generated from said road course data, in which second position data of a second following vehicle which follows the first vehicle, relative to the first vehicle is recorded and its position is entered on the local map, said method comprising the steps:
determining lane information from the distance traveled by the first and second vehicle;
acquiring the position data of the detected second vehicle relative to the road on the local map using said information, wherein one of road markings and landmarks are recorded in order to calculate third position data of the following second vehicle relative to the road from the road course data, the first position data of the vehicle and the second position data of the following vehicle, and wherein, when there is a lane change to a target lane for the purpose of overtaking a third vehicle, a warning about a rapidly following second vehicle which is traveling on the target lane is given, permitting collisions to be avoided, the road geometric data being acquired with a stereoscopic camera arranged on the rear of the first vehicle and fixed location 3-D points are used to determine the road geometric data.

9. The method as claimed in claim 8, wherein the road course data is calculated according to the Kalman filter principle.

10. The method as claimed in claim 8, wherein the lane information is determined from the distance traveled by the respective vehicle, for which said at lease one of road markings and landmarks, which are detected in the vicinity of the vehicle and are incorporated into the map relative to the respective route, are recorded.

11. The method as claimed in claim 8, wherein road markings which are near to the motor vehicle are used said fixed location 3-D points.

12. A method for acquiring a position of a first motor vehicle on a road, road geometric data being recorded on the basis of wheel speeds of the vehicle and travel data on the basis of the movement of the vehicle by a distance (d), first position data of the first motor vehicle relative to the road being calculated from the recorded road geometric data and travel data, road course data being calculated from the road geometric data and the travel data, in which second position data of a second following vehicle which is following the first vehicle relative to the first vehicle is recorded, said method comprising the steps:
calculating third position data of the second following vehicle relative to the road from the road course data, the first position data of the first motor vehicle and the second position data of the second following vehicle;
determining coordinates (xᵢ, zᵢ) of a fixed location 3-D point relative to the first vehicle and coordinates (xᵢ, zᵢ) relative to the road wherein the current position of the first motor vehicle at a time tₙ is calculated during a distance traveled in a certain time period, and in that a relationship between the coordinates relative to the first vehicle and the coordinates relative to the road is set by an equation system in order to suppress interference in the acquired travel data as a result of different wheel circumferences or side wind using said fixed location 3-D point.

13. The method as claimed in claim 9, wherein the lane information is determined from the distance traveled by the respective vehicle, for which said at lease one of road markings and landmarks, which are detected in the vicinity of the vehicle and are incorporated into the map relative to the respective route, are recorded.
